(19) United States
(12) Patent Application Publication
(10) Pub. No.: US 2024/0133323 A1
(43) Pub. Date: Apr. 25, 2024

(54) Motor Fluid Transfer System and Method

(71) Applicant: CirculOil Limited, Brighton (GB)

(72) Inventors: Krishan Arora, Reading (GB); Ross Alexander Dewhurst, Reading (GB)

(21) Appl. No.: 17/768,845

(22) PCT Filed: Oct. 8, 2020
(86) PCT No.: PCT/EP2020/078477

§ 371 Date: Apr. 12, 2022

(30) Foreign Application Priority Data
Oct. 14, 2019 (GB) 1914878.2

(51) Int. Cl. F01M 1/16; F01M 11/04; F01M 11/10

(52) U.S. Cl. CPC F01M 1/16; F01M 11/0458; F01M 11/10; F01M 2001/1071

(57) ABSTRACT

A method of transferring fluid in a motor system includes containing a first volume of fluid in a reservoir of a fluid container that is in fluid communication with a fluid receptacle of a motor and containing a second volume of fluid in the fluid receptacle. A first quantity of fluid is transferred from the fluid receptacle to the reservoir of the replaceable fluid container so as to mix the first quantity of fluid from the fluid receptacle with the volume of fluid in the reservoir of the replaceable fluid container A second quantity of fluid is transferred from the reservoir back to the fluid receptacle.

### BACKGROUND

Many motors use one or more fluids for their operation. Such fluids are often liquids. During operation, fluids may be circulated through a motor to impart various benefits. Often, to ensure that sufficient fluid is available to continuously cycle the fluid through the motor, the fluid is continuously returned to a fluid receptacle of the motor, from which it can be drawn for further circulation.

Fluids circulated through a motor may require periodic changing. Such fluid change may involve draining the fluid from the motor, which may involve time consuming and costly maintenance.

### OVERVIEW

Disclosed herein are methods and systems for regulating fluid in a fluid receptacle. Beneficially, the methods and systems use a fluid container to receive fluid from the fluid receptacle and to return the fluid to the fluid receptacle.

Thus, in a first aspect, the present disclosure provides a method for controlling a fluid drain interval in a motor, the method comprising:
containing a first volume of fluid in a reservoir of a fluid container that is in fluid communication with a fluid receptacle of a motor;
containing a second volume of fluid in the fluid receptacle;
transferring a first quantity of fluid from the fluid receptacle to the reservoir of the fluid container so as to mix the first quantity of fluid from the fluid receptacle with the volume of fluid in the reservoir of the fluid container; and
transferring a second quantity of fluid from the reservoir back to the fluid receptacle.

In another embodiment of the method for controlling a fluid drain interval, the fluid is a lubricant.

In another embodiment of the method for controlling a fluid drain interval, the method further includes:
receiving information indicative of a duration of operation of the motor since transferring the second quantity of fluid from the reservoir back to the fluid receptacle, and
in response to the duration of operation of the motor reaching a predetermined threshold duration, transferring a third quantity of fluid from the fluid receptacle to the reservoir of the fluid container so as to mix the third quantity of fluid from the fluid receptacle with fluid in the reservoir of the fluid container, and transferring a fourth quantity of fluid from the reservoir back to the fluid receptacle.

In another embodiment of the method for controlling a fluid drain interval, the method further includes:
receiving information indicative of a duration of operation of the motor since a previous fluid change, and
in response to the duration of operation of the motor being below a predetermined threshold duration, transferring a third quantity of fluid from the fluid receptacle to the reservoir of the replaceable fluid container so as to mix the third quantity of fluid from the fluid receptacle with fluid in the reservoir of the replaceable fluid container, and transferring a fourth quantity of fluid from the reservoir back to the fluid receptacle.

In another embodiment of the method for controlling a fluid drain interval, the information indicative of a duration of operation of the motor includes at least one of an ignition key position and a battery voltage being above a predetermined threshold voltage.

In another embodiment of the method for controlling a fluid drain interval, the method further includes: in response to receiving an input from a user, initiating the transferring the first quantity of fluid from the fluid receptacle to the reservoir of the fluid container.

In another embodiment of the method for controlling a fluid drain interval, the first quantity of fluid and the second quantity of fluid are transferred using a transfer pump.

In another embodiment of the method for controlling a fluid drain interval, transferring the first quantity of fluid includes operating the transfer pump according to a predetermined control trajectory.

In another embodiment of the method for controlling a fluid drain interval, the predetermined control trajectory includes a predetermined number of pump revolutions.

In another embodiment of the method for controlling a fluid drain interval, the method further includes receiving information indicative of an orientation of the fluid receptacle, and wherein the transferring the first quantity of fluid from the fluid receptacle to the reservoir is carried out in response to the orientation of the fluid receptacle being substantially level.

In another embodiment of the method for controlling a fluid drain interval, the first quantity of fluid and the second quantity of fluid have the same volume.

In another embodiment of the method for controlling a fluid drain interval, the first quantity of fluid has a greater volume than the second quantity of fluid.

In another embodiment of the method for controlling a fluid drain interval, a volume of the first quantity of fluid is in a range from 10% to 50% of the volume of the fluid receptacle.

In a second aspect, the present disclosure provides a non-transitory computer readable medium, having stored thereon, instructions that when executed by a computing device, cause a computing device to perform operations comprising the steps of the method of controlling a fluid drain interval in a motor according to the disclosure.

In a third aspect, the present disclosure provides a fluid transfer system for controlling a fluid drain interval of a motor comprising:
a replaceable fluid container housing a fluid reservoir;
a fluid line configured to provide fluid communication between the fluid reservoir and a fluid receptacle of the motor;
a transfer pump configured to pump fluid through the fluid line between the fluid reservoir of the replaceable fluid container and the fluid receptacle; and
a controller configured to perform operations comprising the steps of the method of controlling a fluid drain interval in a motor according to the disclosure.

In another embodiment of the fluid transfer system for controlling a fluid drain interval, the controller comprises at least one memory and at least one processor, wherein the at least one processor executes instructions stored in the at least one memory so as to carry out the operations.

In another embodiment of the fluid transfer system for controlling a fluid drain interval, the controller comprises at least one of: an application-specific integrated circuit (ASIC) or a field-programmable gate array (FPGA).

In another embodiment of the fluid transfer system for controlling a fluid drain interval, the transfer pump is a bidirectional transfer pump.

In another embodiment of the fluid transfer system for controlling a fluid drain interval, the system further comprises the motor including the fluid receptacle.

In another embodiment of the fluid transfer system for controlling a fluid drain interval, the motor does not include a level sensor for measuring a level of fluid in the fluid receptacle.

In a fourth aspect, the present disclosure provides a method for controlling the volume of fluid in a fluid receptacle, the method comprising:
containing a first volume of fluid in a fluid receptacle of a motor;
transferring fluid from the fluid receptacle to a reservoir of a fluid container so as to evacuate the fluid receptacle; and
transferring a predetermined quantity of fluid from the reservoir back to the fluid receptacle.

In another embodiment of the method for controlling the volume of fluid in the fluid receptacle, the fluid is a lubricant.

In another embodiment of the method for controlling the volume of fluid in the fluid receptacle, the method further includes:
receiving information indicative of a duration of operation of the motor since transferring the predetermined quantity of fluid from the reservoir back to the fluid receptacle, and
in response to the duration of operation of the motor reaching a predetermined threshold duration, transferring fluid from the fluid receptacle of the motor to the reservoir of the replaceable fluid container so as to again evacuate the fluid receptacle, and transferring another predetermined quantity of fluid from the reservoir back to the fluid receptacle.

In another embodiment of the method for controlling the volume of fluid in the fluid receptacle, the information indicative of a duration of operation of the motor includes at least one of an ignition key position and a battery voltage being above a predetermined threshold voltage.

In another embodiment of the method for controlling the volume of fluid in the fluid receptacle, the fluid is transferred using a transfer pump.

In another embodiment of the method for controlling the volume of fluid in the fluid receptacle, the transferring the predetermined quantity of fluid from the reservoir back to the fluid receptacle includes operating the transfer pump according to a predetermined control trajectory.

In another embodiment of the method for controlling the volume of fluid in the fluid receptacle, the predetermined control trajectory includes a predetermined number of pump revolutions.

In another embodiment of the method for controlling the volume of fluid in the fluid receptacle, the method further comprises receiving information indicative of an orientation of the fluid receptacle, and wherein the transferring the fluid from the fluid receptacle to the reservoir so as to evacuate the fluid receptacle is carried out in response to the orientation of the fluid receptacle being substantially level.

In a fifth aspect, the present disclosure provides a non-transitory computer readable medium, having stored thereon, instructions that when executed by a computing device, cause the computing device to perform operations comprising the steps of the method for controlling the volume of fluid in the fluid receptacle of the disclosure.

In a sixth aspect, the present disclosure provides a fluid transfer system for controlling the volume of fluid in a fluid receptacle comprising:
a replaceable fluid container housing a fluid reservoir;
a fluid line configured to provide fluid communication between the fluid reservoir and a fluid receptacle of the motor;
a transfer pump configured to pump fluid through the fluid line between the fluid reservoir of the replaceable fluid container and the fluid receptacle; and
a controller configured to perform operations comprising the steps of the method for controlling the volume of fluid in a fluid receptacle of the disclosure.

In another embodiment of the fluid transfer system for controlling the volume of fluid in the fluid receptacle, the controller comprises at least one memory and at least one processor, wherein the at least one processor executes instructions stored in the at least one memory so as to carry out the operations.

In another embodiment of the fluid transfer system for controlling the volume of fluid in the fluid receptacle, the controller comprises at least one of: an application-specific integrated circuit (ASIC) or a field-programmable gate array (FPGA).

In another embodiment of the fluid transfer system for controlling the volume of fluid in the fluid receptacle, the transfer pump is a bidirectional transfer pump.

In another embodiment of the fluid transfer system for controlling the volume of fluid in the fluid receptacle, the fluid transfer system further comprises the motor including the fluid receptacle.

In another embodiment of the fluid transfer system for controlling the volume of fluid in the fluid receptacle, the motor does not include a level sensor for measuring a level of fluid in the fluid receptacle.

These as well as other aspects, advantages, and alternatives, will become apparent to those of ordinary skill in the art by reading the following detailed description.

### BRIEF DESCRIPTION OF THE DRAWINGS

The accompanying drawings are included to provide a further understanding of the methods and devices of the disclosure, and are incorporated in and constitute a part of this specification. The drawings are not necessarily to scale, and sizes of various elements may be distorted for clarity. The drawings illustrate one or more embodiment(s) of the disclosure, and together with the description serve to explain the principles and operation of the disclosure. In the drawings, similar symbols typically identify similar components, unless context dictates otherwise.

FIG. 1 is a schematic perspective view of a fluid system including a motor according to an example embodiment;

FIG. 2 is a flow chart illustrating a method according to an example embodiment; and

FIG. 3 is a flow chart illustrating a method according to another example embodiment.

### DETAILED DESCRIPTION

Example and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments may be utilized, and other changes may be made, without departing from the scope of the subject matter presented herein.

The example embodiments described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein.

As used herein, with respect to measurements, “about” means +/−5%.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

Reference herein to “one embodiment” or “one example” means that one or more feature, structure, or characteristic described in connection with the example is included in at least one implementation. The phrases “one embodiment” or “one example” in various places in the specification may or may not be referring to the same example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

In the following description, numerous specific details are set forth to provide a thorough understanding of the disclosed concepts, which may be practiced without some or all of these particulars. In other instances, details of known devices and/or processes have been omitted to avoid unnecessarily obscuring the disclosure. While some concepts will be described in conjunction with specific examples, it will be understood that these examples are not intended to be limiting.

The methods and systems described herein are adapted for transferring fluid from a fluid receptacle of a motor to a reservoir of a fluid container that is in fluid communication with the fluid receptacle. The methods and systems further include returning the fluid to the fluid receptacle from the reservoir of the fluid container.

In some embodiments, the motor may be an internal combustion engine and the fluid receptacle may a sump of the engine. Accordingly, in some embodiments the fluid may be a lubricant that is configured to lubricate moving parts of the motor. For example, the fluid may be an engine lubricant. In other embodiments, the motor may be an electric motor and the fluid receptacle may contain fluid used with the electric motor. For example, the fluid may be a coolant or a lubricant used in the electric motor. Moreover, methods of the invention may also be applicable to other fluids used in other machinery, such as coolants used with batteries.

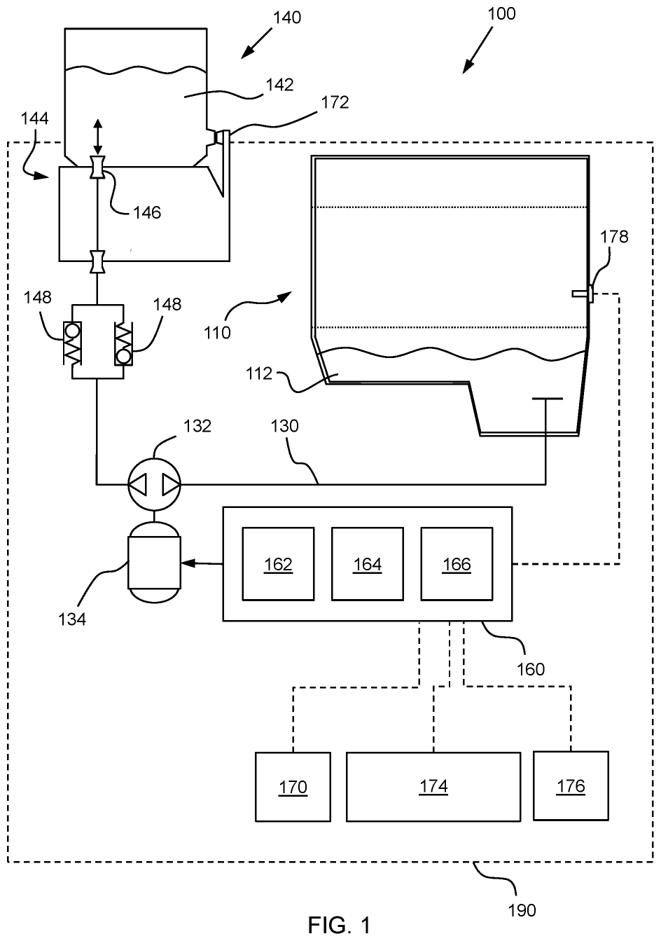

With reference to the Figures, FIG. 1 shows a fluid transfer system 100 for moving fluid between a fluid receptacle of a motor and a reservoir of a fluid container. Fluid transfer system 100 includes a motor 110 with a fluid receptacle 112 and a reservoir 142 of a fluid container 140. The fluid receptacle 112 is in fluid communication with the reservoir 142 via fluid line 130. A fluid pump 132 may be disposed in the fluid line 130 that is operable to transfer the fluid from the fluid receptacle 112 of the motor 110 to the reservoir 142 in the fluid container 140 and from the reservoir 142 back to the fluid receptacle 112.

In some embodiments, the fluid may be a lubricant in the form of a lubricating oil that includes at least one base stock and at least one lubricating oil additive. Suitable base stocks include bio-derived base stocks, mineral oil derived base stocks, synthetic base stocks, and semi synthetic base stocks. Suitable lubricating oil additives, for example motor lubricating oil additives, may be organic and/or inorganic compounds. In some embodiments, the lubricating oil includes a range of 60% to 90% by weight base stock and 40% to 10% by weight additives. The lubricating oils may be mono-viscosity grade or multi-viscosity grade motor lubricating oil. Examples of suitable lubricating oil include single purpose lubricating oil and multipurpose lubricating oil.

The methods and systems of the disclosure may be used in or with a wide variety of different machines that utilize a motor, and the fluid transfer system may be part of or associated with the machine. For example, in the fluid transfer system 100 shown in FIG. 1, the motor 112 is part of a machine 190. The machine 190 may have any of a variety of different forms. For example, the machine 190 may be a small or mid-sized apparatus or tool that is powered by an engine or electric motor, such as a lawnmower, a generator, or a compressor. In some embodiments, the machine 190 may be a hand tool, such as a chainsaw, hedge trimmer, or leaf blower. Further, the machine 190 may be a vehicle, such as a car, a boat, a motorcycle, a train or an airplane, for example. The foregoing machines are merely examples, and the methods and systems described herein can also be used with a variety of other machines.

In some embodiments, the motor 110 may be a small engine or an engine that might not have various electronic systems, including sensors and communication interfaces. For example, the motor might not have a fluid level sensor associated with the fluid receptacle 112.

In some embodiments, the fluid container 140 may be a replaceable fluid container that is adapted to be coupled to the motor 110 via a dock 144 or other temporary fluid coupling configuration. The dock 144 may be a part of the machine 190 so that the fluid container 140 can be connected with and disconnected with the fluid receptacle 112 and other parts of the machine 190 by inserting and removing the fluid container 140 from the dock 144. The dock 144 may include one or more fluid port couplings 146 that are configured to receive corresponding fluid port couplings of the fluid container 140 that are in fluid communication with the reservoir 140.

In some embodiments, the fluid container 140 is an oil cell that is adapted for providing fresh oil to the motor 110 during an oil change and removing spent oil from the motor after it has been used. Accordingly, the fluid reservoir 142 may hold lubricating oil, for example, motor lubricating oil. In particular, a new oil cell 140 can provide fresh, refreshed or unused lubricating oil which may conveniently replace a fluid container holding used or spent lubricating oil. During such an oil change operation, the reservoir 142 of the fluid container 140 may retain a reserve quantity of fluid for use in the methods described herein.

In some embodiments, the fluid pump 132 may be a rotary pump. For example, the fluid pump may be a gear pump, trochoid pump, or vane pump. In some embodiments, the fluid pump 132 may include a bidirectional fluid pump that is configured to pump the fluid in either direction. In other embodiments, the fluid transfer system 100 may include two pumps that respectively pump the fluid from the fluid receptacle 112 to the reservoir 142 and from the reservoir 142 to the fluid receptacle 112. Still, in some embodiments, the fluid line 130 between the fluid receptacle 112 and the reservoir 142 may include valve arrangements to reroute the flow path so that the fluid pump 132 can transfer the fluid in either direction. The term pump, as used herein, includes any device that uses energy to move a fluid. For example, the pump can be formed by any actuator or mechanism that moves fluid, such as rotary, piston or other pumps.

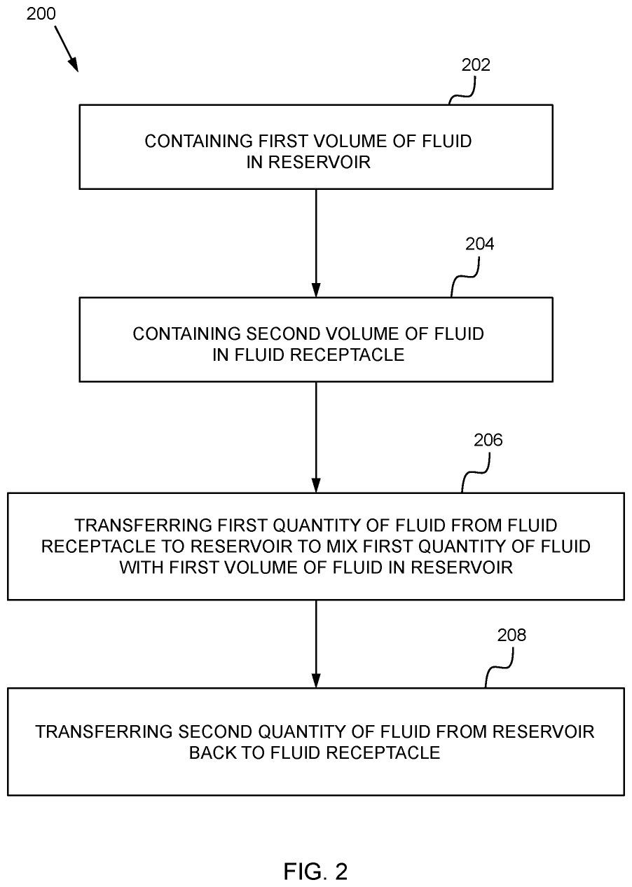

FIG. 2 shows an example embodiment of a method 200 of transferring fluid between a fluid receptacle of a motor and a reservoir of a fluid container. As shown by block 202, the method 200 may involve containing a first volume of fluid in a reservoir of a fluid container that is in fluid communication with a fluid receptacle of a motor. Further, the method may involve, as shown by block 204, containing a second volume of fluid in the fluid receptacle. As shown by block 206, the method may also involve transferring a first quantity of fluid from the fluid receptacle to the reservoir of the fluid container so as to mix the first quantity of fluid from the fluid receptacle with the first volume of fluid in the reservoir. Further, as shown by block 208, the method may involve transferring a second quantity of fluid from the reservoir back to the fluid receptacle.

In embodiments of the disclosure, the method 200 may be carried out in the order described above. For example, the method begins with fluid contained in both the reservoir and the fluid receptacle as set forth in blocks 202 and 204. From this state, the method includes transferring the first quantity of fluid from the fluid receptacle to the reservoir in block 206. Subsequently, in block 208, the second quantity of fluid is transferred from the reservoir back to the fluid receptacle.

With reference to the fluid transfer system 100 shown in FIG. 1, method 200 begins with a first volume of fluid contained in the reservoir 142 of fluid container 140 and a second volume of fluid contained in the fluid receptacle 112 of the motor 110. Using the transfer pump 132, a first quantity of fluid is transferred through fluid line 130 from the fluid receptacle 112 to the reservoir 142. Once in the reservoir 142, the first quantity of fluid transferred from the fluid receptacle 112 mixes with the first volume of fluid in the reservoir 142. A portion of the mixed fluid in the reservoir 142 is then transferred back to the fluid receptacle 112 using the transfer pump 132. In particular, a second quantity of fluid is transferred from the reservoir 142 back to the fluid receptacle 112.

The methods and systems of the disclosure may use any of a variety of different strategies to promote mixing of the first quantity of fluid that is transferred to the reservoir 142 with the first volume of fluid previously contained in the reservoir 142. For example, the transfer pump 132 may be operated to pump the first quantity of fluid at an increased speed so as to promote mixing of the first quantity of fluid with the first volume of fluid. As another example, valves or couplings in the fluid line 130 may be operated to partially close so as to promote mixing of the first quantity of fluid with the first volume of fluid. As another example, the fluid container 140 may include one or more baffles, and the first quantity of fluid may be directed through the baffles so as to promote mixing of the first quantity of fluid with the first volume of fluid. As yet another example, the fluid container 140 may include an agitator, and the agitator may be operated so as to promote mixing of the first quantity of fluid with the first volume of fluid.

In some embodiments, the first volume of fluid contained in the reservoir 142, the first quantity of fluid transferred from the fluid receptacle 112 to the reservoir 142, and the second quantity of fluid transferred from the reservoir 142 to the fluid receptacle 112 may be in different states. For example, in some embodiments, the first volume of fluid in the reservoir 142 may be in a first state and the first quantity of fluid transferred from fluid receptacle 112 to the reservoir 142 may be in a second state. Differences in the states of the fluid may result from the use of the fluid by the motor 110.

For example, in the case of a lubricant, the first volume of fluid in the reservoir 142 may be a fresh lubricant while the first quantity of fluid transferred from the fluid receptacle 112 to the reservoir 142 may be a used or spent lubricant. Accordingly, the second state of the lubricant that is transferred to the reservoir 142 from the fluid receptacle 112 may have characteristics associated with lubricant used in the motor 110, while the first state of the lubricant contained in the reservoir 142 may have characteristics associated with fresh lubricant. For example, the first state of the lubricant contained in the reservoir 142 may have a higher concentration of consumable additives, such as antioxidants, than the lubricant that is transferred from the fluid receptacle 112 to the reservoir 142. Likewise, the second state of the lubricant that is transferred from the fluid receptacle 112 to the reservoir 142 may have a higher concentration of contaminants than the first volume of fluid contained in the reservoir 142.

After the first quantity of fluid transferred from the fluid receptacle 112 mixes with the first volume of fluid contained in the reservoir 142, the mixed fluid may be in a third state, and the fluid in the third state may be transferred back to the fluid receptacle 112 for use in the motor 110. For example, again in the case of a lubricant, the second quantity of fluid that is transferred back to fluid receptacle 112 may include a higher concentration of consumable additives than the first quantity of fluid that was transferred from the fluid receptacle 112, but a lower concentration of consumable additives than the first volume of fluid in the reservoir 142 prior to mixing with the transferred first quantity of fluid. Likewise, the second quantity of fluid that is transferred back to fluid receptacle 112 may include a lower concentration of contaminants than the first quantity of fluid that was transferred from the fluid receptacle 112, but a higher concentration the first volume of fluid originally contained in the reservoir 142.

The process of removing fluid from the fluid receptacle 112, mixing the removed fluid from the fluid receptacle 112 with the volume of fluid in the reservoir 142, and returning the mixed fluid to the fluid receptacle 112 provides a way to add constituents of the fluid from the reservoir 142 into the fluid that is being circulated through the motor 110. Accordingly, in embodiments where the steps of removing fluid from the fluid receptacle and returning the mixed fluid to the fluid receptacle are carried out periodically, the reservoir 142 of the fluid container 140 effectively acts as an additional volume of the fluid receptacle 112. By periodically mixing fluid from the fluid receptacle 112 with fluid in the reservoir 142, a greater volume of fluid can be used with the motor 110, which in turn provides a way for a greater volume of fresh fluid or fluid with a higher concentration of desirable constituents to circulate through the motor 110.

Beneficially, the process of removing fluid from the fluid receptacle 112, mixing the removed fluid from the fluid receptacle 112 with the volume of fluid in the reservoir 142, and returning the mixed fluid to the fluid receptacle 112 provides a way to increase the fluid drain interval of the motor 110. The term fluid drain interval, as used herein, refers to a time period between fluid changes of the motor 110. In some embodiments in which the fluid is an engine lubricant, the fluid drain interval refers to a time period between oil changes.

Method 200 provides a way to control the fluid drain interval of a motor. In some embodiments, method 200 may increase the fluid drain interval of the motor 110 and thereby reduce the frequency of replacement of the fluid of the motor 110. For example, method 200 may increase the fluid drain interval of the motor 110 by many hours including, for example, 50 to 200 hours. Thus, for example, method 200 may increase the fluid drain interval of the motor from 100 hours to 200 hours.

In some embodiments, the first quantity of fluid is the same as the second quantity of fluid. In particular, in some embodiments, the first quantity of fluid that is transferred from the fluid receptacle 112 of the motor 110 to the reservoir 142 of the fluid container 140 is the same as the second quantity of fluid that is transferred from the reservoir 142 back to the fluid receptacle 112. Accordingly, in such embodiments, the fluid transfer does not impact the volume of fluid in the fluid receptacle 112 after the method 200 is completed. In other embodiments, the second quantity of fluid has a greater volume than the first quantity of fluid. For example, in some embodiments, up to 10% greater, or up to 5% greater volume of fluid is transferred from the reservoir 142 back to the fluid receptacle 112 than was originally removed from the fluid receptacle 112 to the reservoir 142. This additional fluid that is transferred back to the fluid receptacle 112 can accommodate fluid that is lost during operation of the motor 110. For example, in embodiments in which the fluid is an engine lubricant, a portion of the lubricant may be consumed during operation. By transferring a greater volume of fluid back into the fluid receptacle than was removed from the fluid receptacle, the lubricant can be replenished and kept at an adequate operating volume.

In some embodiments the method 200 includes transferring less than a majority of the fluid in the fluid receptacle 112 of the motor 110 to the reservoir 142 of the fluid container 140. For example, in some embodiments, the first quantity of fluid is in a range from 10% to 50% of the volume of fluid in the fluid receptacle 112. Alternatively, in other embodiments all, or nearly all, of the fluid in the fluid receptacle 112 may be transferred to the reservoir 142 as explained in more detail below.

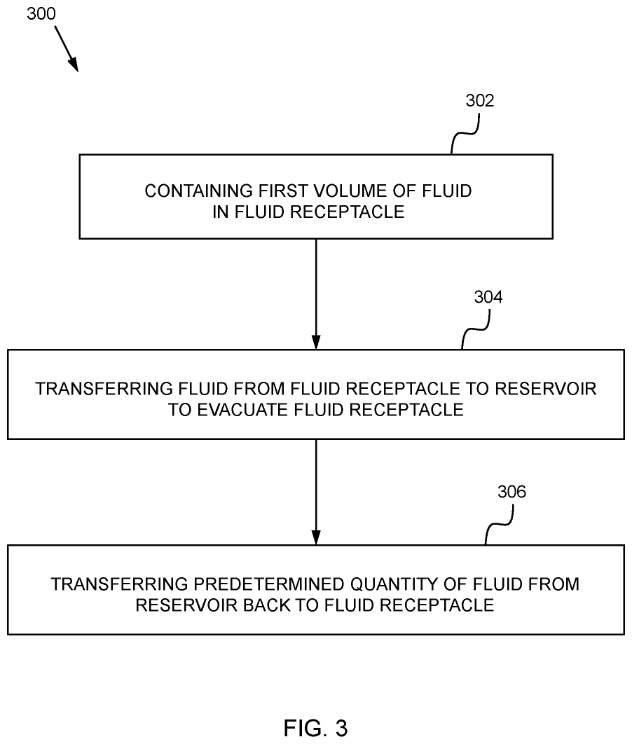

FIG. 3 shows another example embodiment of a method 300 of transferring fluid between a fluid receptacle of a motor and a reservoir of a fluid container. As shown by block 302, the method 300 may involve containing a first volume of fluid in a receptacle of a motor. As shown by block 304, the method may also involve transferring fluid from the fluid receptacle to a reservoir of a fluid container so as to evacuate the fluid receptacle. Further, as shown by block 306, the method may also involve transferring a predetermined quantity of fluid from the reservoir back to the fluid receptacle.

In embodiments of the disclosure, the method 300 may be carried out in the order described above. For example, the method begins with fluid contained in the fluid receptacle as set forth in block 302. From this state, the method includes transferring fluid from the fluid receptacle to the reservoir in block 304. Subsequently, in block 306, a predetermined quantity of fluid is transferred from the reservoir back to the fluid receptacle.

With reference to the fluid transfer system 100 shown in FIG. 1, method 300 begins with a first volume of fluid contained in the fluid receptacle 112 of the motor 110. Using the transfer pump 132, fluid may be transferred through fluid line 130 from the fluid receptacle 112 to the reservoir 142 until the fluid receptacle 112 has been evacuated. Subsequently, the transfer pump 132 may be reversed and a predetermined quantity of fluid may be transferred from the reservoir 142 back to the fluid receptacle 112.

The term evacuate, as used herein, refers to removal of substantially all of the fluid in the fluid receptacle. For example, the fluid pump 132 may remove all of the fluid in the fluid receptacle that is capable of being removed by the fluid pump 132 in a single operation, but without waiting for the fluid to drain from the inner surface of the fluid receptacle and without cleaning the fluid receptacle 112. For example, in some embodiments, at least 95% of the fluid may be transferred from the fluid receptacle 112 so as to evacuate the fluid receptacle 112. In other embodiments, at least 99% of the fluid may be transferred from the fluid receptacle 112 so as to evacuate the fluid receptacle 112.

Motors typically have a target fluid quantity within a range of working control limits for the fluid receptacle. Beneficially, transferring fluid to the reservoir 142 until the fluid receptacle 112 has been evacuated and subsequently transferring a predetermined quantity of fluid from the reservoir 142 back to the fluid receptacle 112 provides a way to maintain the fluid within a range of working control limits for the fluid receptacle 112.

Method 300 may be used to control a volume of fluid in the fluid receptacle. In some embodiments, method 300 may maintain the fluid within a range of working control limits for the fluid receptacle 112 and thereby improve operation of the motor 110. In some embodiments, method 300 may reduce maintenance of the motor 110.

In some embodiments, the fluid transfer system 100 may include a pump motor 134, such as an electric motor, coupled to the fluid pump 132 and configured to drive the fluid pump 132. In some embodiments, the fluid pump 132 and the pump motor 134 may be provided as separate elements that are connected by a shaft or other coupling. In other embodiments, the fluid pump 132 and the pump motor 134 may be provided in a single housing.

Embodiments of the system of the disclosure may include a controller and the methods of the disclosure may be carried out by the controller. FIG. 1 includes a schematic representation of a controller 160 included in the fluid transfer system 100. The controller 160 includes a non-transitory computer-readable medium with program instructions stored thereon for performing the method of the disclosure. In some embodiments, the controller 160 may include at least one memory 162, at least one processor 164, and/or a network interface 166. Additionally or alternatively, in other embodiments, the controller 160 may include a different type of computing device operable to carry out the program instructions. For example, in some embodiments, the controller may include an application-specific integrated circuit (ASIC) that performs processor operations, or a field-programmable gate array (FPGA).

While the controller 160 of the fluid transfer system 100 may be included in a single unit and/or provided in a distinct housing, as shown in FIG. 1, in other embodiments, at least some portion of the controller 160 may be separate from the housing. For example, in some embodiments, one or more parts of the controller 160 may be part of a smartphone, tablet, notebook computer, or wearable device. Further, in some embodiments, the controller 160 may be a client device, i.e., a device actively operated by the user, while in other embodiments, the controller 160 may be a server device, e.g., a device that provides computational services to a client device. Moreover, other types of computational platforms are also possible in embodiments of the disclosure.

The memory 162 is a computer-usable memory, such as random access memory (RAM), read-only memory (ROM), non-volatile memory such as flash memory, a solid state drive, a hard-disk drive, an optical memory device, and/or a magnetic storage device.

The processor 164 of the controller 160 includes computer processing elements, e.g., a central processing unit (CPU), a digital signal processor (DSP), or a network processor. In some embodiments, the processor 164 may include register memory that temporarily stores instructions being executed and corresponding data and/or cache memory that temporarily stores performed instructions. In certain embodiments, the memory 162 stores program instructions that are executable by the processor 164 for carrying out the methods and operations of the disclosure, as described herein.

The network interface 166 provides a communications medium, such as, but not limited to, a digital and/or an analog communication medium, between the controller 160 and other computing systems or devices. In some embodiments, the network interface may operate via a wireless connection, such as IEEE 802.11 or BLUETOOTH, while in other embodiments, the network interface 166 may operate via a physical wired connection, such as an Ethernet connection. Still in other embodiments, the network interface 166 may communicate using another convention.

In embodiments of the methods of the disclosure, steps of the methods may be carried out by the controller 160. For example, the controller 160 may send a control signal to the transfer pump 132 or the pump motor 134 in order to control the transfer pump 132 so as to transfer the fluid according to a particular control trajectory. For example, the controller 160 may send a control signal in order to operate the transfer pump 132 for a certain number of revolutions, at a particular speed, for a particular duration, or combinations thereof in order to transfer the desired quantity of fluid.

In some embodiments, the steps of transferring fluid from the fluid receptacle 112 of the motor 110 to the reservoir 142 of the fluid container 140 and then transferring fluid back to the fluid receptacle 112 of the motor 110 may be carried out in a short duration of time, such as less than 10 minutes, less than 5 minutes, or even less than 1 minute. For example, in some embodiments, the transfer pump 132 may be controlled to transfer fluid from the fluid receptacle 112 to the reservoir 140 for 10 seconds, to wait 10 seconds as the transferred fluid mixes with the volume of fluid in the reservoir, and then transfer fluid back to the receptacle 112 for 10 seconds. Accordingly, the entire process may take about half of a minute. In other embodiments, the steps may be carried out over a longer time frame. For example, in some embodiments, the fluid may be transferred from the fluid receptacle 112 of the motor 110 to the reservoir 140 in incremented pulses over a longer period of time in order to enhance mixing. Further, in some embodiments, the controller 160 may wait for a longer duration, such as minutes or hours, before returning the fluid from the reservoir 140 to the fluid receptacle 112 of the motor.

In some embodiments, the controller 160 initiates the methods of the disclosure in response to certain criteria. For example, in some embodiments, the controller 160 may initiate the transfer of fluid from the fluid receptacle 112 to the reservoir 142 in response to receiving certain data signals that are indicative of appropriate conditions of the system. Various different signals may be used to determine whether the conditions are appropriate for initiating the fluid transfer. For example, in some embodiments, the controller 160 initiates the transfer of fluid from the fluid receptacle 112 to the reservoir 142 only if the motor is level. Accordingly, the controller 160 may receive a signal from an orientation sensor 176, or the controller 176 may include an orientation sensor, and the controller 160 may initiate the transfer of fluid in response to the signal from the orientation sensor indicating that the motor 110 is substantially level. For example, the controller 160 may initiate the transfer of fluid in response to the signal from the orientation sensor indicating that the motor is oriented at an angle of less than 20 degrees from level, less than 10 degrees from level, or less than 5 degrees from level. In some embodiments, the orientation sensor 176 is an accelerometer.

Likewise, in some embodiments, the controller 160 initiates the transfer of fluid from the fluid receptacle 112 to the reservoir 142 only if the motor 110 is not in operation. Thus, the controller 160 may receive a signal from a central motor control unit that indicates the operating state of the motor 110 and initiate the transfer of fluid from the fluid receptacle 112 in response to the signal from the central motor control unit indicating that the motor 110 is not in operation. Alternatively, the controller 160 may receive a signal from the ignition key 170 indicating the ignition key position and proceed to initiate the transfer of fluid from the fluid receptacle in response to the signal from the ignition key 170 indicating that the ignition key 170 is in an off position. Accordingly, the controller 160 provides a safety check to ensure that the fluid is not entirely removed from the motor 110 while the motor 110 is operating.

Further, in some embodiments, the controller 160 initiates the transfer of fluid only if the fluid container 140 is situated on the dock 144. For example, in some embodiments the controller 160 may receive a signal from a sensor 172 of the dock 144 that is indicative of whether the fluid container 140 is situated in the dock 144, and the controller 160 may initiate the transfer of fluid from the fluid receptacle 112 to the reservoir 142 in response to the signal from the sensor 172 indicating that the fluid container 140 is located on the dock 144.

Further, in some embodiments, the controller 160 may receive a signal from a battery 174 indicative of a voltage of the battery 174. The controller 160 may initiate the transfer of fluid from the fluid receptacle 112 to the reservoir 142 in response to the signal from the battery 174 indicating that the battery voltage is above a threshold voltage value. In some embodiments, the threshold voltage value is 11 volts. Accordingly, the controller 160 provides a safety check to ensure a method of the disclosure is not initiated at a time when there is insufficient power to complete the method, or when there is insufficient power to subsequently start the motor 110.

Further, in some embodiments, the controller 160 may receive a signal from a temperature sensor 178 indicative of a temperature of the motor 110. The controller 160 may initiate the transfer of fluid from the fluid receptacle 112 to the reservoir 142 in response to the signal from the temperature sensor 178 indicating that the temperature of the motor 110 is below threshold temperature value. In some embodiments, the threshold temperature value is ambient temperature. Accordingly, the controller 160 provides a safety check to ensure that the fluid is not entirely removed from the motor 110 while the motor 110 is hot.

In some embodiments, the controller 160 initiates the methods of the disclosure in response to the duration of motor 110 operation since a previous event. For example, in some embodiments, the controller 160 initiates the methods of the disclosure only in response to information indicative of the duration of operation of the motor 110 since a previous fluid change being below a predetermine threshold. For example, in some embodiments, the controller 160 receives information indicative of the accumulated duration of operation of the motor 100 since a previous fluid change, and initiates the method in response to the duration being below the predetermined threshold. In some embodiments, the controller 160 does not initiate the method if the duration is above the predetermined threshold. Further, in some embodiments, the controller 160 may send a signal to a user that the fluid should be changed rather in response to receiving information indicative of the duration of operation of the engine being above the predetermined threshold.

Further, in some embodiments, the controller 160 initiates the methods of the disclosure in response to receiving information that is indicative of the duration of operation of the motor 110 since a previous cycle of the method being greater than a threshold. For example, in some embodiments, the controller 160 is configured to carry out a method of the disclosure at certain intervals of motor operation, such as after a certain numbers of hours of operation, e.g., 4 hours, 6 hours, 8 hours or 10 hours of operation.

In some embodiments, the information that is indicative of the duration of operation of the motor 110 is a signal from a central motor controller that calculates motor operation duration, and sends a duration signal to the controller 160. In other embodiments, the controller 160 calculates the duration of operation of the motor 110 based on other signals. For example, in some embodiments, the controller 160 calculates an estimate of the duration of operation of the motor 110 based on the position of the ignition key 170. In other embodiments, the controller 160 calculates an estimate of the duration of operation of the motor 110 based on the voltage of a battery 174. For example, the controller 160 may estimate that the motor 110 is being operated when the battery voltage is high. Still, in other embodiments, the controller 160 may estimate that the motor 110 is being operated based on the ignition key 170 position and the battery 174 voltage. For example, the controller 160 may estimate that the motor 110 is in operation when the battery voltage is high and the ignition key 170 is in the on position. Thus, the controller 160 may measure the duration that these two criteria are met to estimate the overall duration of operation of the motor 110, and initiate the methods of the disclosure based on this calculation, as explained above.

In some embodiments, the controller 160 operates the transfer pump 132 according to a particular control trajectory in order to transfer fluid between the reservoir 142 of the fluid container 140 and the receptacle 112 of the motor 110. For example, in some embodiments, the controller 160 may send a control signal to pump motor 134 to operate the transfer pump 132 through a certain number of cycles in order to transfer the desired quantity of fluid. Further, in some embodiments, the controller 160 may send a control signal to pump motor 134 to operate the transfer pump 132 at a specific speed for a specific duration in order transfer the desired quantity of fluid.

Further, in some embodiments, the controller 160 may monitor the operation of the transfer pump 132 and modify the control signal based on signals from the transfer pump 132. For example, in some embodiments, the controller 160 may monitor the speed of the pump motor 134 using a sensor in order to determine operation of the transfer pump 132. The controller may then modify the control trajectory based on the identified speed in order to transfer the desired amount of fluid. Similarly, in some embodiments, the controller 160 may monitor the current drawn by the pump motor 134 and modify the control trajectory based on the current drawn by the pump motor 134. For example, the controller 160 may use the current drawn by the pump motor 134 to determine that the fluid receptacle 112 of the motor 110 is evacuated. The controller 160 may thus conclude the signal to drive the pump motor 134 when the current draw diminishes, as the controller 160 may determine that the drop in current is an indication that the fluid has been evacuated.

Further, in some embodiments, the controller 160 may initiate the transfer of fluid from the fluid receptacle 112 to the reservoir 142 in response to receiving an input from a user. In some embodiments, the machine 190 may include a button, and the user may provide the input to the controller 160 by depressing the button.

The fluid port couplings of the fluid system 100, for example the couplings 146 between the dock 144 and the fluid container 140, provides a fluid connection when the components of the coupling 146 are attached. In some embodiments, the fluid port coupling connection is configured to allow fluid flow in a single direction. For example, the connected fluid port couplings may provide a fluid connection for a single fluid path and the fluid coupling may include a check valve allowing flow in only a single direction. In other embodiments, the fluid port coupling connection may provide fluid flow in two directions. For example, the fluid port coupling connection may form a single fluid path with unrestricted flow in both directions. Alternatively, in some embodiments, the fluid port coupling connection may form more than one fluid path, such that liquid may flow in one direction through one fluid path of the connection and in the opposite direction through a second fluid path of the fluid port coupling connection. In this case, both paths may include check valves without preventing flow in either direction. In other embodiments, the fluid line 130 may include one or more valves for controlling fluid flow through fluid line 130. For example, fluid line 130 in FIG. 1 includes a pair of opposing check valves 148 that limit unintended movement of fluid through the fluid line 130.

In some embodiments of the methods described herein, fluid that is transferred between the reservoir 142 of the fluid container 140 and the fluid receptacle 112 of the motor 110 may be passed through a filter before returning to the fluid receptacle of the motor. For example, the fluid container 140 may include a filter, and the fluid from the fluid receptacle 112 may be directed through the filter as it enters or leaves the reservoir 142. Likewise a filter may be included in the fluid line 130 between the motor and the fluid container so that the fluid is filtered as it passes from one element to the other.

The above detailed description describes various features and functions of the disclosed systems, devices, and methods with reference to the accompanying Figures. In the Figures, similar symbols typically identify similar components, unless context dictates otherwise. The illustrative embodiments described in the detailed description, Figures, and claims are not meant to be limiting. Other embodiments can be utilized, and other changes can be made, without departing from the scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

### Embodiments

Embodiment 1. A method for controlling a fluid drain interval in a motor, the method comprising:
containing a first volume of fluid in a reservoir of a fluid container that is in fluid communication with a fluid receptacle of a motor;
containing a second volume of fluid in the fluid receptacle;
transferring a first quantity of fluid from the fluid receptacle to the reservoir of the fluid container so as to mix the first quantity of fluid from the fluid receptacle with the first volume of fluid in the reservoir of the fluid container; and
transferring a second quantity of fluid from the reservoir back to the fluid receptacle.

Embodiment 2. The method according to embodiment 1, wherein the fluid is a lubricant.

Embodiment 3. The method according to embodiment 1, further comprising:
receiving information indicative of a duration of operation of the motor since transferring the second quantity of fluid from the reservoir back to the fluid receptacle, and
in response to the duration of operation of the motor reaching a predetermined threshold duration, transferring a third quantity of fluid from the fluid receptacle to the reservoir of the fluid container so as to mix the third quantity of fluid from the fluid receptacle with fluid in the reservoir of the fluid container, and transferring a fourth quantity of fluid from the reservoir back to the fluid receptacle.

Embodiment 4. The method according to embodiment 1, further comprising:
receiving information indicative of a duration of operation of the motor since a previous fluid change, and
in response to the duration of operation of the motor being below a predetermined threshold duration, transferring a third quantity of fluid from the fluid receptacle to the reservoir of the replaceable fluid container so as to mix the third quantity of fluid from the fluid receptacle with fluid in the reservoir of the replaceable fluid container, and transferring a fourth quantity of fluid from the reservoir back to the fluid receptacle.

Embodiment 5. The method according to embodiment 3 or embodiment 4, wherein the information indicative of a duration of operation of the motor includes at least one of an ignition key position and a battery voltage being above a predetermined threshold voltage.

Embodiment 6. The method according to embodiment 1, further comprising in response to receiving an input from a user, initiating the transferring the first quantity of fluid from the fluid receptacle to the reservoir of the fluid container.

Embodiment 7. The method according to embodiment 1, wherein the first quantity of fluid and the second quantity of fluid are transferred using a transfer pump.

Embodiment 8. The method according to embodiment 7, wherein transferring the first quantity of fluid includes operating the transfer pump according to a predetermined control trajectory.

Embodiment 9. The method according to embodiment 8, wherein the predetermined control trajectory includes a predetermined number of pump revolutions.

Embodiment 10. The method according to embodiment 1, further comprising receiving information indicative of an orientation of the fluid receptacle, and wherein the transferring the first quantity of fluid from the fluid receptacle to the reservoir is carried out in response to the orientation of the fluid receptacle being substantially level.

Embodiment 11. The method according to embodiment 1, wherein the first quantity of fluid and the second quantity of fluid have the same volume.

Embodiment 12. The method according to embodiment 1, wherein the second quantity of fluid has a greater volume than the first quantity of fluid.

Embodiment 13. The method according to embodiment 1, wherein a volume of the first quantity of fluid is in a range from 10% to 50% of the volume of fluid in the fluid receptacle.

Embodiment 14. A non-transitory computer readable medium, having stored thereon, instructions that when executed by a computing device, cause a computing device to perform operations comprising the steps of the method as embodimented in any of embodiments 1 to 13.

Embodiment 15. A fluid transfer system for a motor comprising:
a replaceable fluid container housing a fluid reservoir;
a fluid line configured to provide fluid communication between the fluid reservoir and a fluid receptacle of the motor;
a transfer pump configured to pump fluid through the fluid line between the fluid reservoir of the replaceable fluid container and the fluid receptacle; and
a controller configured to perform operations comprising the steps of the method as embodimented in any of embodiments 1 to 13.

Embodiment 16. The fluid transfer system according to embodiment 15, wherein the controller comprises at least one memory and at least one processor, and wherein the at least one processor executes instructions stored in the at least one memory so as to carry out the operations.

Embodiment 17. The fluid transfer system according to embodiment 15, wherein the controller comprises at least one of: an application-specific integrated circuit (ASIC) or a field-programmable gate array (FPGA).

Embodiment 18. The fluid transfer system according to embodiment 15, wherein the transfer pump is a bidirectional transfer pump.

Embodiment 19. The fluid transfer system according to embodiment 15, further comprising the motor including the fluid receptacle.

Embodiment 20. The fluid transfer system according to embodiment 19, wherein the motor does not include a level sensor for measuring a level of fluid in the fluid receptacle.

Embodiment 21. A method for controlling the volume of fluid in a fluid receptacle, the method comprising:
containing a first volume of fluid in a fluid receptacle of a motor;
transferring fluid from the fluid receptacle to a reservoir of a fluid container so as to evacuate the fluid receptacle; and
transferring a predetermined quantity of fluid from the reservoir back to the fluid receptacle.

Embodiment 22. The method according to embodiment 21, wherein the fluid is a lubricant.

Embodiment 23. The method according to embodiment 21, further comprising:
receiving information indicative of a duration of operation of the motor since transferring the predetermined quantity of fluid from the reservoir back to the fluid receptacle, and
in response to the duration of operation of the motor reaching a predetermined threshold duration, transferring fluid from the fluid receptacle of the motor to the reservoir of the replaceable fluid container so as to again evacuate the fluid receptacle, and transferring another predetermined quantity of fluid from the reservoir back to the fluid receptacle.

Embodiment 24. The method according to embodiment 23, wherein the information indicative of a duration of operation of the motor includes at least one of an ignition key position and a battery voltage being above a predetermined threshold voltage.

Embodiment 25. The method according to embodiment 1, further comprising initiating the transferring fluid from the fluid receptacle to the reservoir so as to evacuate the fluid receptacle in response to receiving input from a user.

Embodiment 26. The method according to embodiment 21, wherein the fluid is transferred using a transfer pump.

Embodiment 27. The method according to embodiment 26, wherein the transferring the predetermined quantity of fluid from the reservoir back to the fluid receptacle includes operating the transfer pump according to a predetermined control trajectory.

Embodiment 28. The method according to embodiment 27, wherein the predetermined control trajectory includes a predetermined number of pump revolutions.

Embodiment 29. The method according to embodiment 21, further comprising receiving information indicative of an orientation of the fluid receptacle, and wherein the transferring the fluid from the fluid receptacle to the reservoir so as to evacuate the fluid receptacle is carried out in response to the orientation of the fluid receptacle being substantially level.

Embodiment 30. A non-transitory computer readable medium, having stored thereon, instructions that when executed by a computing device, cause the computing device to perform operations comprising the steps of the method as embodimented in any of embodiments 21 to 29.

Embodiment 31. A fluid transfer system for a motor comprising:
a replaceable fluid container housing a fluid reservoir;
a fluid line configured to provide fluid communication between the fluid reservoir and a fluid receptacle of the motor;
a transfer pump configured to pump fluid through the fluid line between the fluid reservoir of the replaceable fluid container and the fluid receptacle; and
a controller configured to perform operations comprising the steps of the method as embodimented in any of embodiments 21 to 29.

Embodiment 32. The fluid transfer system according to embodiment 31, wherein the controller comprises at least one memory and at least one processor, wherein the at least one processor executes instructions stored in the at least one memory so as to carry out the operations.

Embodiment 33. The fluid transfer system according to embodiment 31, wherein the controller comprises at least one of: an application-specific integrated circuit (ASIC) or a field-programmable gate array (FPGA).

Embodiment 34. The fluid transfer system according to embodiment 31, wherein the transfer pump is a bidirectional transfer pump.

Embodiment 35. The fluid transfer system according to embodiment 31, further comprising the motor including the fluid receptacle.

Embodiment 36. The fluid transfer system according to embodiment 35, wherein the motor does not include a level sensor for measuring a level of fluid in the fluid receptacle.

1. A method for controlling a fluid drain interval in a motor, the method comprising:
containing a first volume of fluid in a reservoir of a fluid container that is in fluid communication with a fluid receptacle of a motor;
containing a second volume of fluid in the fluid receptacle;
transferring a first quantity of fluid from the fluid receptacle to the reservoir of the fluid container so as to mix the first quantity of fluid from the fluid receptacle with the first volume of fluid in the reservoir of the fluid container; and
transferring a second quantity of fluid from the reservoir back to the fluid receptacle.

2. The method according to claim 1, wherein transferring the first quantity of fluid from the fluid receptacle to the reservoir of the fluid container evacuates the fluid receptacle.

3. The method according to claim 1, further comprising:
receiving information indicative of a duration of operation of the motor since transferring the second quantity of fluid from the reservoir back to the fluid receptacle, and
in response to the duration of operation of the motor reaching a predetermined threshold duration, transferring a third quantity of fluid from the fluid receptacle to the reservoir of the fluid container so as to mix the third quantity of fluid from the fluid receptacle with fluid in the reservoir of the fluid container, and transferring a fourth quantity of fluid from the reservoir back to the fluid receptacle.

4. The method according to claim 3, wherein the information indicative of a duration of operation of the motor includes at least one of an ignition key position and a battery voltage being above a predetermined threshold voltage.

5. The method according to claim 1, further comprising:
receiving information indicative of a duration of operation of the motor since a previous fluid change, and
in response to the duration of operation of the motor being below a predetermined threshold duration, transferring a third quantity of fluid from the fluid receptacle to the reservoir of the replaceable fluid container so as to mix the third quantity of fluid from the fluid receptacle with fluid in the reservoir of the replaceable fluid container, and transferring a fourth quantity of fluid from the reservoir back to the fluid receptacle.

6. The method according to claim 1, further comprising in response to receiving an input from a user, initiating the transferring the first quantity of fluid from the fluid receptacle to the reservoir of the fluid container.

7. The method according to claim 1, wherein transferring the first quantity of fluid includes operating a transfer pump according to a predetermined control trajectory.

8. The method according to claim 7, wherein the predetermined control trajectory includes a predetermined number of pump revolutions.

9. The method according to claim 1, wherein the first quantity of fluid and the second quantity of fluid have the same volume.

10. The method according to claim 1, wherein the second quantity of fluid has a greater volume than the first quantity of fluid.

11. A non-transitory computer readable medium, having stored thereon, instructions that when executed by a computing device, cause a computing device to perform operations comprising the steps of:
transferring a first quantity of fluid from a fluid receptacle of a motor to a reservoir of a fluid container so as to mix the first quantity of fluid from the fluid receptacle with a first volume of fluid in the reservoir of the fluid container; and
transferring a second quantity of fluid from the reservoir back to the fluid receptacle.

12. A fluid transfer system for a motor comprising:
a replaceable fluid container housing a fluid reservoir;
a fluid line configured to provide fluid communication between the fluid reservoir and a fluid receptacle of the motor;
a transfer pump configured to pump fluid through the fluid line between the fluid reservoir of the replaceable fluid container and the fluid receptacle; and
a controller configured to perform operations comprising the steps of:
transferring a first quantity of fluid from the fluid receptacle of the motor to the reservoir of the fluid container so as to mix the first quantity of fluid from the fluid receptacle with a first volume of fluid in the reservoir of the fluid container; and
transferring a second quantity of fluid from the reservoir back to the fluid receptacle.

13. The fluid transfer system according to claim 12, wherein the controller comprises at least one memory and at least one processor, and wherein the at least one processor executes instructions stored in the at least one memory so as to carry out the operations.

14. The fluid transfer system according to claim 12, further comprising the motor including the fluid receptacle.

15. The fluid transfer system according to claim 14, wherein the motor does not include a level sensor for measuring a level of fluid in the fluid receptacle.
